(19) United States
(12) Patent Application Publication
(10) Pub. No.: US 2023/0376995 A1
(43) Pub. Date: Nov. 23, 2023

(54) ONE-TO-ONE DIGITAL MEDIA MODELING SYSTEMS AND METHODS FOR OPTIMIZING DIGITAL MEDIA REACH WITHIN DIGITAL NETWORKS

(71) Applicant: The Procter & Gamble Company, Cincinnati, OH (US)

(72) Inventors: Umur TUENER, Geneva (CH); Brad S. HOEKZEMA, Cincinnati, OH (US); Marco BUNGARO, Geneva (CH)

(21) Appl. No.: 18/319,589

(22) Filed: May 18, 2023

Related U.S. Application Data
(60) Provisional application No. 63/343,127, filed on May 18, 2022.

(51) Int. Cl. G06Q 30/0242; G06Q 30/0204

(52) U.S. Cl. CPC G06Q 30/0244; G06Q 30/0243; G06Q 30/0204

(57) ABSTRACT

One-to-one digital media modeling systems and methods are disclosed for optimizing digital media reach within digital networks. A data seed is generated that defines a seed audience of users defined by targeting criteria for a digital media asset. The data seed is provided to a lookalike algorithm that applies the data seed to a userbase comprising user data of additional users to generate a lookalike media model comprising a campaign audience dataset defining a plurality of audience datasets having a relevancy score and each having users selected from the seed audience or the additional users. An exposed lookalike audience dataset is created by merging each of the plurality of audience datasets having the relevancy score above a relevancy threshold value, wherein the exposed lookalike audience dataset defines a subset of targeted users. The digital media asset is then transmitted across a digital network for display on a user device.

### CROSS-REFERENCE TO RELATED APPLICATIONS

This application claims the benefit, under 35 U.S.C. § 119(e), to U.S. Provisional Patent Application No. 63/343,127, filed on May 18, 2022, the entire disclosure of which is herein incorporated by reference in its entirety.

### FIELD

The present disclosure generally relates to one-to-one digital media modeling systems and methods, and more particularly to one-to-one digital media modeling systems and methods for optimizing digital media reach within digital networks.

### BACKGROUND

Modern Internet communications typically involve various platforms and servers in communication with each other. Such platforms and servers typically comprise their own internal networks, subnetworks, or other computer networks and resources that share information and content, which may include digital media assets. Digital media assets typically comprise data-rich digital payload content, such as images, video, text, audio, and the like. The digital media assets may take on various forms, including digital infographics, advertisements (ads), or the like, and take up sizeable bandwidth or otherwise computational resources to transmit via a computer network, such as the Internet or subnetworks thereof, including private and/or public networks thereof.

In particular, digital media asset distribution typically involves dissemination of digital media assets across several computer networks in order to arrive at an intended destination (e.g., an edge computer device). Such dissemination of data-rich content can reduce network resources or take up bandwidth otherwise within a given computer network. This can be problematic when the distribution or dissemination of such digital media assets is redundant, thereby causing the digital media assets to be needlessly transmitted on computer networks to and displayed on edge devices. This can be especially problematic given that online platforms are typically controlled, hosted, or otherwise maintained by separate entities that do not share dissemination or distribution information with one another, which causes increased network traffic when a need exists to ensure that digital media assets are transmitted, received, and displayed to end-users on these digital platforms. Such redundant distribution and dissemination results in digital waste, including over-utilization of network bandwidth and the creation of needless digital network traffic. It also creates frustration on the part of end-users whose devices must render redundant digital media content.

Still further, traditional methodologies of distribution and targeting of users that rely on demographics alone overestimate or overcast the number of users who receive digital media assets. This results in an overabundance of digital media asset distribution, which can also result in over-utilization of network bandwidth.

For the foregoing reasons, there is a need for one-to-one digital media modeling systems and methods for optimizing digital media reach within digital networks, as further described herein.

### SUMMARY

The one one-to-one digital media modeling systems and methods as described herein provide improved distribution and targeting of end users, and therefore result in reduced computer network traffic, power consumption, and less processor utilization among computing devices, which in turn results in less computer bandwidth utilized as whole within a network environment. The present disclosure describes use of an automated data flow architecture that uses proprietary data of a defined ecosystem to significantly improve digital media asset distribution and targeting accuracy. The proprietary database comprises robust data or big data scaling resulting in accurate digital media asset distribution and targeting of users having defined characteristics. That is, big data is used by the one-to-one modeling systems and methods described herein to track and optimize on-target reach and on-target accuracy in digital network environments. These robust distribution, targeting, and tracking methodologies provide significant efficiencies of computing resources in a network environment.

In real-world testing, the one-to-one modeling systems and methods, as described herein, have resulted in 52% accuracy of reaching intended targets, e.g., target computers or device of intended users. Results of the targeting may be tracked with a proprietary methodology of on-target reach and on-target accuracy measurement. Such efforts result in reducing media and network data traffic waste caused by ad impressions delivered over a computer network to non-category users. For example, using digital one-to-one optimization as described herein has reduced digital media assets as transmitted across a digital network. In one measurement this has resulted in reduction network traffic, as measured in dollar costs, in the amount of $22.5 million, where digital assets would have otherwise been prepared and transmitted across a network resulting in wasted bandwidth and computing resources.

By contrast, prior art systems rely on third party data alone (e.g., data from online third-party platform servers alone) for targeting digital media assets to given segments of users. Those segments are often too broad having generic demographics (e.g., women aged 20+), which resulted in over-transmission of digital assets in a computer network, and, at the same time, wasted impressions delivered to non-intended users. In addition, accuracy of such prior arts systems was very low (e.g., only 5%).

The one-to-one digital media modeling systems and methods described herein, on the other hand, track and utilize application (app) (e.g., mobile app) based user activity to enhance targeting and therefore reduce network redundancy, usage, and traffic. The one-to-one digital media modeling systems and methods are configured to scale by using big data determined by tracking and storing user interactions with such apps. For example, with digital media and the related data privacy landscape evolving rapidly, it is difficult to scale distribution without dissemination and/or overuse of computer networks. However, the one-to-one digital media modelling systems and methods describe herein provide scaling within and across multiple and different regions, while at the same time reducing computer network traffic, and saving and improving valuable compute and bandwidth resources.

More specifically, as described herein, a one-to-one digital media modeling method is disclosed for optimizing digital media reach within digital networks. In various aspects, the one-to-one digital media modeling method comprises generating, by one or more processors, a data seed defining a seed audience of users defined by targeting criteria for a digital media asset. The one-to-one digital media modeling method further comprises providing, by the one or more processors, the data seed to a lookalike algorithm to generate a lookalike media model. The lookalike algorithm applies the data seed to a userbase comprising user data of additional users. Further, the lookalike media model comprises a campaign audience dataset defining a plurality of audience datasets each having users selected from at least one of the seed audience or the additional users. Each of the plurality of audience datasets has a relevancy score. The one-to-one digital media modeling method further comprises creating by the one or more processors, an exposed lookalike audience dataset by merging each of the plurality of audience datasets having the relevancy score above a relevancy threshold value, wherein the exposed lookalike audience dataset defines a subset of targeted users. The one-to-one digital media modeling method further comprises transmitting, by the one or more processors, the digital media asset across a digital network to a user device of at least one user of the targeted users of the exposed lookalike audience. The user device is configured to display the digital media asset on a graphical user interface (GUI).

In addition, as described herein, a one-to-one digital media modeling system is disclosed. The one-to-one digital media modeling system is configured to optimize digital media reach within digital networks. In various aspects, the one-to-one digital media modeling system may comprise a server comprising one or more processors and one or more memories. The one-to-one digital media modeling system may further comprise computing instructions stored on the one or more memories of the server, and when executed by the one or more processors, may cause the one or more processors to generate, by the one or more processors, a data seed defining a seed audience of users defined by targeting criteria for a digital media asset. The computing instructions, when executed, may further cause the one or more processors to provide, by the one or more processors, the data seed to a lookalike algorithm to generate a lookalike media model. The lookalike algorithm applies the data seed to a userbase comprising user data of additional users. The lookalike media model comprises a campaign audience dataset defining a plurality of audience datasets each having users selected from at least one of the seed audience or the additional users. Each of the plurality of audience datasets has a relevancy score. The computing instructions, when executed, may further cause the one or more processors to create by the one or more processors, an exposed lookalike audience dataset by merging each of the plurality of audience datasets having the relevancy score above a relevancy threshold value. The exposed lookalike audience dataset defines a subset of targeted users. The computing instructions, when executed, may further cause the one or more processors to transmit, by the one or more processors, the digital media asset across a digital network to a user device of at least one user of the targeted users of the exposed lookalike audience.

Further, as described herein, a tangible, non-transitory computer-readable medium storing instructions for optimizing digital media reach within digital networks is disclosed. The instructions, when executed by one or more processors, may cause the one or more processors to generate, by one or more processors, a data seed defining a seed audience of users defined by targeting criteria for a digital media asset. The instructions, when executed by one or more processors, may further cause the one or more processors to provide, by the one or more processors, the data seed to a lookalike algorithm to generate a lookalike media model. The lookalike algorithm applies the data seed to a userbase comprising user data of additional users. The lookalike media model comprises a campaign audience dataset defining a plurality of audience datasets each having users selected from at least one of the seed audience or the additional users, and each of the plurality of audience datasets having a relevancy score. The instructions, when executed by one or more processors, may further cause the one or more processors to create by the one or more processors, an exposed lookalike audience dataset by merging each of the plurality of audience datasets having the relevancy score above a relevancy threshold value. The exposed lookalike audience dataset defines a subset of targeted users. The instructions, when executed by one or more processors, may further cause the one or more processors to transmit, by the one or more processors, the digital media asset across a digital network to a user device of at least one user of the targeted users of the exposed lookalike audience.

In accordance with the above, and with the disclosure herein, the present disclosure includes improvements in computer functionality or improvements to other technologies at least because the disclosure describes that, e.g., a distribution server, the edge computing devices with which the distribution server communicates (e.g., a user computer device), and the underlying computer network upon which the distribution server and the computing device communicate, are each improved where the distribution server is able to reduce transmission of digital media assets (e.g., comprising sizable data payloads) from being transmitted across the computer network and displayed or rendered by the edge computing device. For example, the distribution server may track or determine, through merging identifiers of a user using one or more edge devices on one or more open web and/or online platforms in order to determine a limited subset of digital media assets to be transmitted across the network. That is, by reduction of digital media assets, the digital media distribution frequency management methods and system described herein reduce digital media transmitted across digital networks and platforms. This results in fewer messages (e.g., digital media assets) sent across network, whether it may be an internal or an external network. This also results in less compute power and memory use by nodes of the system by not having to process and/or send redundant digital media assets that would otherwise be sent across computer networks.

One-to-one digital media modeling systems and methods are described herein for reducing digital media across digital networks and platforms. The one-to-one digital media modeling systems and methods, as described herein, comprise implementing systems that enable omni-channel digital asset deduplication by providing frequency management in computer networks. This minimizes digital waste by excluding from transmission in the computer network, digital media assets (such as digital ads that comprise graphics, images, text, audio, etc.) that would otherwise be transmitted and/or displayed or rendered on various computing devices connected to the computer network. For example, users who should not receive a given digital media asset can be excluded from receiving the same digital media asset across the computer network thereby reducing overcast digital touchpoints across the network.

For similar reasons, the present disclosure relates to improvements to other technologies or technical fields at least because the present disclosure describes or introduces improvements to computing networks, where the one-to-one digital media modeling systems and methods, as described herein, improve the overall health of computing networking by reducing digital media across digital networks and platforms, thereby increasing bandwidth and data packet traffic for each given computer and network that would otherwise be involved in the transmission of such digital media assets.

In addition, the present disclosure includes specific features other than what is well-understood, routine, conventional activity in the field, or adding unconventional steps that confine the claim to a particular useful application, e.g., one-to-one digital media modeling systems and methods for optimizing digital media reach within digital networks, as further described herein.

Advantages will become more apparent to those of ordinary skill in the art from the following description of the preferred aspects which have been shown and described by way of illustration. As will be realized, the present aspects may be capable of other and different aspects, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an aspect of a particular aspect of the disclosed system and methods, and that each of the Figures is intended to accord with a possible aspect thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present aspects are not limited to the precise arrangements and instrumentalities shown, wherein:

FIG. 1 illustrates an example one-to-one digital media modeling system configured to optimize digital media reach within digital networks, in accordance with various aspects disclosed herein.

FIG. 2 illustrates an example graphic user interface as rendered on a display screen of a user computing device, in accordance with various aspects disclosed herein.

FIG. 3 illustrates an example one-to-one digital media modeling method for optimizing digital media reach within digital networks, in accordance with various aspects disclosed herein.

FIG. 4 illustrates example output of the one-to-one digital media modeling system and method as described herein for FIGS. 1 and 3, and in accordance with various aspects disclosed herein.

FIG. 5 illustrates a further example one-to-one digital media modeling method for optimizing digital media reach within digital networks, in accordance with various aspects disclosed herein.

The Figures depict preferred aspects for purposes of illustration only. Alternative aspects of the systems and methods illustrated herein may be employed without departing from the principles of the invention described herein.

### DETAILED DESCRIPTION OF THE INVENTION

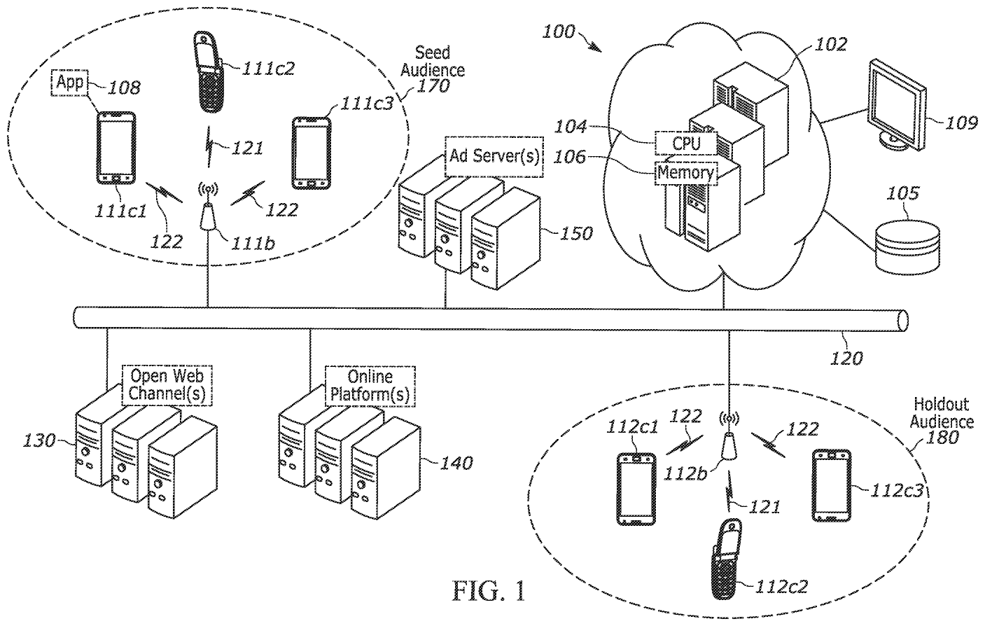

FIG. 1 illustrates an example one-to-one digital media modeling system 100 configured to optimize digital media reach within digital networks, in accordance with various aspects disclosed herein. In the example aspect of FIG. 1, one-to-one digital media modeling system 100 includes server(s) 102, which may comprise one or more computer servers. In various aspects server(s) 102 comprise multiple servers, which may comprise multiple, redundant, or replicated servers as part of a server farm. In still further aspects, server(s) 102 may be implemented as cloud-based servers, such as a cloud-based computing platform. For example, distribution server(s) 102 may be any one or more cloud-based platform(s) such as MICROSOFT AZURE, GOOGLE CLOUD, AMAZON AWS, or the like. Server(s) 102 may include one or more processor(s) 104 as well as one or more computer memories 106. In various aspects, server(s) 102 may be referred to herein as “distribution server(s).”

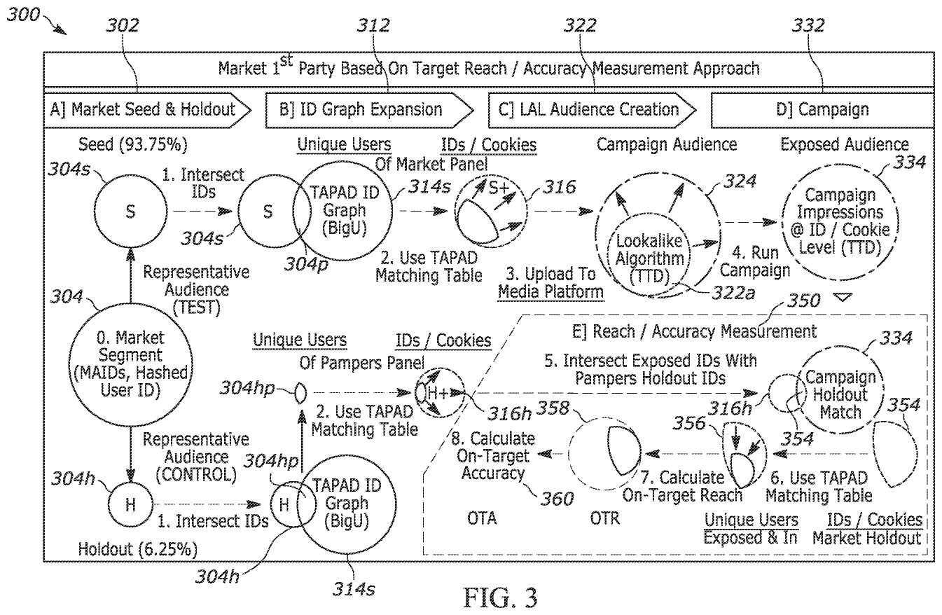

Memory 106 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memories 106 may store an operating system (OS) (e.g., Microsoft Windows, Linux, UNIX, etc.) capable of facilitating the functionalities, apps, methods, or other software as discussed herein. Memory 106 may also store computing instructions for implementing any one or more of the one-to-one digital media modeling methods as described herein, including as described herein with respect to FIG. 3. Additionally, or alternatively, digital media assets (e.g., digital adds), user data, impression count data, impression frequency data or messages, any other data or information, as described herein, may also be stored in memory 106 and/or database 105. Database 105 is accessible or otherwise communicatively coupled to distribution server(s) 102. In addition, memories 106 may also store machine readable instructions, including any of one or more application(s) (e.g., an application as described herein), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. The computing instructions or applications as described herein may be executed by the processor(s) 104.

The processor(s) 104 may be connected to the memories 106 via a computer bus responsible for transmitting electronic data, data packets, or otherwise electronic signals to and from the processor(s) 104 and memories 106 in order to implement or perform the machine readable instructions, methods, processes, elements or limitations, as illustrated, depicted, or described for the various flowcharts, illustrations, diagrams, figures, and/or other disclosure herein.

Processor(s) 104 may interface with memory 106 via the computer bus to execute an operating system (OS). Processor(s) 104 may also interface with the memory 106 via the computer bus to create, read, update, delete, or otherwise access or interact with the data stored in memories 106 and/or the database 105 (e.g., a relational database, such as Oracle, DB2, MySQL, or a NoSQL based database, such as MongoDB). The data stored in memories 106 and/or database 105 may include all or part of any of the data or information described herein, including, for example, digital media assets (e.g., digital media asset 204) and/or other assets or data regarding users, impress counts, impression IDs, or the like, or as otherwise described herein.

Distribution server(s) 102 may further include a communication component configured to communicate (e.g., send and receive) data via one or more external/network port(s) to one or more networks or local terminals, such as computer network 120 and/or terminal 109 (for rendering or visualizing) described herein. For example, in some aspects, distribution server(s) 102 may include a client-server platform technology such as ASP.NET, Java J2EE, Ruby on Rails, Node.js, a web service or online API, responsive for receiving and responding to electronic requests. The distribution server(s) 102 may implement the client-server platform technology that may interact, via the computer bus, with the memory 106 (including the applications(s), component(s), API(s), data, etc. stored therein) and/or database 105 to implement or perform the machine readable instructions, methods, processes, elements or limitations, as illustrated, depicted, or described for the various flowcharts, illustrations, diagrams, figures, and/or other disclosure herein.

In various aspects, the distribution server(s) 102 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to computer network 120. In some aspects, computer network 120 may comprise a private network or local area network (LAN). Additionally, or alternatively, computer network 120 may comprise a public network such as the Internet.

Distribution server(s) 102 may further include or implement an operator interface configured to present information to an administrator or operator and/or receive inputs from the administrator or operator. As shown in FIG. 1, an operator interface may provide a display screen (e.g., via terminal 109). Distribution server(s) 102 may also provide I/O components (e.g., ports, capacitive or resistive touch sensitive input panels, keys, buttons, lights, LEDs), which may be directly accessible via, or attached to, distribution server(s) 102, or may be indirectly accessible via or attached to terminal 109. According to some aspects, an administrator or operator may access the server 102 via terminal 109 to review information, make changes, add or modify digital media assets, configure impression count and/or frequency, and/or perform other functions as described herein.

As described herein, in some aspects, distribution server(s) 102 may perform the functionalities as discussed herein as part of a “cloud” network or may otherwise communicate with other hardware or software components within the cloud to send, retrieve, or otherwise analyze data or information described herein.

In general, a computer program or computer based product, application, or code (e.g., the model(s), such as AI models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 104 (e.g., working in connection with the respective operating system in memories 106) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

As shown in FIG. 1, distribution server(s) 102 are communicatively connected, via computer network 120 to the one or more user computing devices 111c1-111c3 and 112c1-112c3 via base stations 111b and 112b. In some aspects, base stations 111b and 112b may comprise cellular base stations, such as cell towers, communicating to the one or more user computing devices 111c1-111c3 and 112c1-112c3 via wireless communications 121 based on any one or more of various mobile phone standards, including NMT, GSM, CDMA, UMMTS, LTE, 5G, or the like. Additionally, or alternatively, base stations 111b and 112b may comprise routers, wireless switches, or other such wireless connection points communicating to the one or more user computing devices 111c1-111c3 and 112c1-112c3 via wireless communications 122 based on any one or more of various wireless standards, including by non-limiting example, IEEE 802.11a/b/c/g (WIFI), the BLUETOOTH standard, or the like.

Any of the one or more user computing devices 111c1-111c3 and 112c1-112c3 may comprise mobile devices and/or client devices for accessing and/or communications with distribution server(s) 102. Such mobile devices may comprise one or more mobile processor(s) and/or an imaging device for capturing images. In various aspects, user computing devices 111c1-111c3 and 112c1-112c3 may comprise a mobile phone (e.g., a cellular phone), a tablet device, a personal data assistance (PDA), or the like, including, by non-limiting example, an APPLE iPhone or iPad device or an ANDROID based mobile phone or tablet.

In various aspects, the one or more user computing devices 111c1-111c3 and 112c1-112c3 may implement or execute an operating system (OS) or mobile platform such as APPLE iOS and/or ANDROID operation system. Any of the one or more user computing devices 111c1-111c3 and 112c1-112c3 may comprise one or more processors and/or one or more memories for storing, implementing, or executing computing instructions or code, e.g., a mobile application, as described in various aspects herein. As shown in FIG. 1, application (app) 108 and/or an application as described herein, or at least portions thereof, may also be stored locally on a memory of a user computing device (e.g., user computing device 111c1). App 108 may be configured to display digital media assets or other information, collect data from users, track user activity or interaction of users, or perform or execute other actions as described herein.

In the example of FIG. 1, computing devices 111c1-111c3 are devices of a seed audience 170 that comprises users defined by targeting criteria for one or more given digital media assets. Computing devices 112c1-112c3, on the other hand, are devices of a holdout audience 180 that comprises users defined by the targeting criteria for one or more given digital media assets, but where the holdout audience 180 of users is different from the seed audience 170 of users. In various aspects, the server(s) 102 via processor(s) 104 may generate a data seed defining the seed audience 170. The data seed (or different data therein) may be used to generate or otherwise determine the holdout audience 180.

User computing devices 111c1-111c3 and 112c1-112c3 may each comprise a wireless transceiver to receive and transmit wireless communications 121 and/or 122 to and from base stations 111b and 112b. In various aspects, digital media assets (e.g., digital media asset 204) may be transmitted via computer network 120 to user computing devices 111c1-111c3 and 112c1-112c3, open web channel(s) 130 and/or platforms(s) 140 for distribution, sharing, suppressing, and/or allowing digital media assets, as described herein.

Open web channel(s) 130 may comprise one or more servers hosting a website or webpage accessible on the Internet, where such website or webpage may comprise digital resources or online content such as provided by websites for the NEW YORK TIMES, USA TODAY, or similar digital, public, or accessible online resource that may be openly accessed without a user account or user page, or otherwise user-based platform with which a user can interact with. Additionally, or alternatively, open web channel(s) 130 may comprise an impression ID aggregator, such as, by way of non-limiting example, as provided by the TTD platform. In various aspects, the open web channel(s) 130 may track, store, detect, or otherwise determine a set of impression identifiers (IDs) of a digital media asset (e.g., digital media asset 204) as displayed on one or more GUIs, such as a GUI of any one or more of computing devices 111c1-111c3 and 112c1-112c3. That is, the digital media assets may be provided from the open web channel(s) 130 for display on the GUI(s). In various aspects, the set of impression IDs may be determined by server(s) 102, such as via download or retrieval from open web channel(s) 130. Still further, in various aspects an identifier of a user may be determined as well as an impression count of the user based on the set of impression IDs and an open web ID of the user. The impression count may define a number of times the digital media asset has been displayed to the user via the GUI(s) of the one or more open web digital channels, e.g., the digital media assets as provided from the one open web channel(s) 130 to the GUI(s) of any one or more of computing devices 111c1-111c3 and 112c1-112c3.

With further reference to FIG. 1, online platform(s) 140 may comprise one or more online based digital media content distribution platforms, which may comprise one or more servers. Online platform(s) 140 may comprise media based platforms such as the FACEBOOK platform and/or YOUTUBE platform, or the like, where users may interact with media, such as digital media assets, images, videos, or the like. A GUI of the online based digital media content distribution platform may comprise an application (app) as provided by a given digital media content distribution platform, such as the FACEBOOK app or website and/or the YOUTUBE app or website.

More generally, identifiers (IDs) of specific users may be determined. For example, in various aspects, the identifier may comprise a mobile advertising identifier (MAID), which is a unique pseudo-anonymous identifier tied to a mobile phone of a user (and thus may be used to uniquely identify the user). For example, both the APPLE IOS operating system and the GOOGLE ANDROID operating system provide unique identifiers for underlying devices that enable data to be pseudo-anonymously be tied back to the mobile device from where such data was collected. Such identifiers are known as mobile advertising identifiers, mobile ad IDs, or simply MAIDs. The APPLE IOS operating system implementation of MAID named the “Identifier For Advertisers” (IDFA). The IDFA consists of 32 hyphen-separated characters, e.g., “918F1D4F-D195-4A8B-AF47-44683FE11DB9.” The GOOGLE ANDROID operating system implementation of MAID is named the “Advertising Identifier” (Ad Id). Like the IDFA, it consists of 32 hyphen-separated characters, e.g., “3f097372-f01e-4b64-984c-395ae5828ee6.

More generally, identifiers may be used to identify a user. For example, the identifier of the user may comprise one or more of a MAID, a hashed identifier of the user (e.g., a hashed email), an email address of the user, a name of the user, a surname of the user, a postal address of the user, and/or a phone number of the user. In some aspects, different and/or additional identifiers may be used based on geography. For example, hashed emails, hashed phone numbers, and MAIDs may be utilized to identify users (as identifiers) in North America (NA) because such information tends to be readily available in that geography. Use of multiple identifiers tends to increase match rates or percentages between impression data and the target audiences for reducing digital media across digital networks and platforms as described herein.

Still further, impression identifiers (IDs) may be determined for a digital media asset(s) as displayed on one or more graphic user interfaces (GUIs). The digital media asset or digital creative may have been previously displayed on graphical areas of a web page or a mobile device (e.g., mobile app) of an open web channel. Additionally, the set of impression IDs may comprise information determined from an impression ID aggregator, such as the TTD, which may provide impression IDs for how many times a digital media asset has been displayed on a given open web channel. Examples of open web channels (e.g., open web channels 130) include the NEW YORK TIMES webpage, the WALL STREET JOURNAL webpage, a sports website (e.g., ESPN website), gaming apps, and the like.

The open web channels 130 may provide tracking of users (e.g., by web cookies or device IDs of a given device, such as an IPHONE device ID, etc.), where such information is provided back to an impression ID aggregator (e.g., TTD). In some aspects, the impression IDs or otherwise impression data may comprise an ID graph linking impression IDs to mobile advertising identifier (MAID) or other identifiers, for purposes of achieving higher matching or identification of user. Open web channels 130 may provide this data to distribution server(s) 102 for analysis and determination as described herein.

In some aspects, the set of impression IDs comprise impressions of the digital media asset as displayed on one or more GUIs, or otherwise tracked by open web channels 130, downloaded by servers 102, or otherwise provided to distribution servers 102, for example, within a given time period (e.g., 30 minutes, 1 day, 7 days, or other time period).

The set of impression IDs may correspond to different digital media asset campaigns, such as campaign 1, campaign 2, etc. A digital media asset campaign may comprise a period of time and/or platform for a given target audience for which to provide or show a digital media asset. For example, a campaign (e.g., such as campaign 1) may relate to showing digital media asset 204 to fathers on an online platform 140 (e.g., the FACEBOOK platform) for a period of 1 month. It is to be understood that additional and/or different campaigns are also contemplated, such as campaigns for other target audiences (e.g., mothers, teenagers, etc.) and/or for other or different time periods (e.g., 1 day, 1 week, several months, a year, etc.).

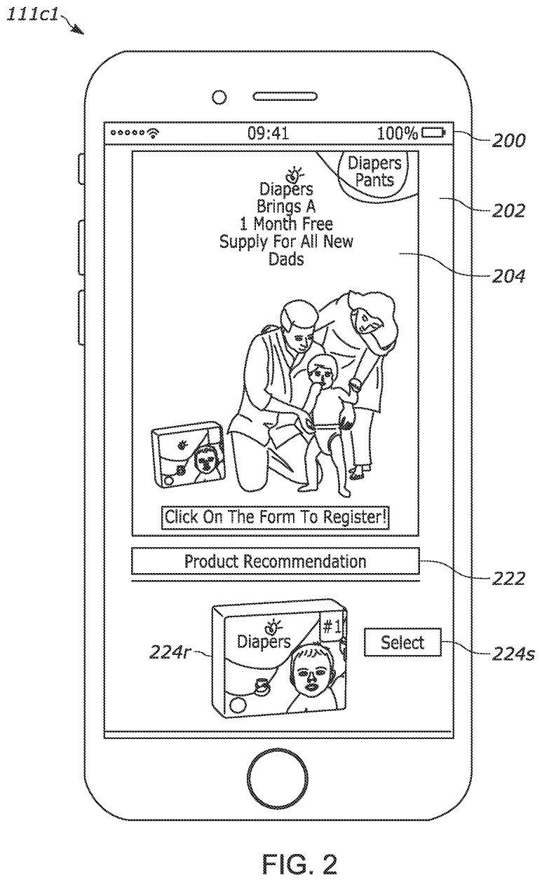

Once a user is identified (e.g., based on the open web ID and/or identifier of the user) an impression count may be determined where the impression count defines a number of times a digital media asset (e.g., digital media asset 204) has been displayed to the user via the one or more GUIs of the one or more open web digital channels. In the example of FIG. 2, the digital media asset 204 has been shown to the first user for campaign (e.g., a campaign regarding offering diapers to fathers for a 30 day period, as shown for FIG. 2).

FIG. 2 illustrates an example graphic user interface (GUI) as rendered on a display screen 200 of a user computing device (e.g., user computing device 111c1), in accordance with various aspects disclosed herein. For example, as shown in the example of FIG. 2, graphic user interface 202 may be implemented or rendered via an app executing on user computing device 111c1. For example, as shown in the example of FIG. 2, graphic user interface 202 may be implemented or rendered via a native app executing on user computing device 111c1. In the example of FIG. 2, user computing device 111c1 is a user computer device as described for FIG. 1, e.g., where 111c1 is illustrated as an APPLE iPhone that implements the APPLE iOS operating system and that has display screen 200. User computing device 111c1 may execute one or more native applications (apps) on its operating system, including, for example, an app (e.g., app 108) as described herein. Such native apps may be implemented or coded (e.g., as computing instructions) in a computing language (e.g., SWIFT) executable by the user computing device operating system (e.g., APPLE iOS) by the processor of user computing device 111c1. In various aspects, the app (e.g., an app 108) executing on a mobile devices, such as user computing device 111c1, may be referred to as a distribution app, designed to display content to the user, including digital media assets (e.g., digital media asset 204), and/or other information, data, or images as described herein. In various aspects, the distribution app may comprise an app of an online platform (e.g., a platform app of an online platform 140) or of an open web channel (e.g., an open web channel app of an open web channel 130).

Additionally, or alternatively, graphic user interface 202 may be implemented or rendered via a web interface, such as via a web browser application, e.g., SAFARI and/or CHROME based web browsers, browser apps, and/or other such web browser or the like. In such aspects, the web browser would return HTML code provided by, or otherwise associated with, the online platform 140 and/or open web channel 130.

Digital media assets may comprise images, graphics, text, and/or audio configured for display on or via open web channel(s) 130 and/or online platform(s) 140. Digital media assets may also be referred to as “digital creatives.” Digital media asset 204 is an example digital media asset comprising a digital advertisement (ad). In the example of FIG. 2, digital media asset 204 comprises a digital ad targeted to a target audience (e.g., fathers or “dads”) of children who are toddlers (e.g., between ages 1-3). Digital media asset 204 comprises graphics and text pertaining to the target audience (e.g., fathers) and relating to a product for the target audience (e.g., diapers for toddlers). In the example of FIG. 2, digital media asset 204 may be displayed via an app (e.g., app 108) or a website, such as an app or website of an online platform (e.g., a platform app of an online platform 140) or of an open web channel (e.g., an open web channel app of an open web channel 130). It is to be understood that digital media asset 204 is provided as an example and that additional and/or different digital media assets (e.g., digital ads), targeting additional and/or different target audiences may be used, implemented, or distributed as described herein.

With further reference to FIG. 2, in some aspects, a digital media asset may comprise a product recommendation. Alternatively, a product recommendation may be displayed separately (but part of GUI 202) along with digital media asset. For example, a product recommendation (e.g., product recommendation 222) may be for a manufactured product. For example, as shown in FIG. 2, graphic user interface 202 recommends a product (e.g., manufactured product 224r (e.g., absorbent article size 2)), which may be based on the target audience of digital media asset 204.

Graphic user interface 202 may further include a selectable user interface (UI) button 224s to allow the user to select for purchase or shipment the corresponding product (e.g., manufactured product 222r). In some aspects, selection of selectable UI button 224s may cause the recommended product(s) to be shipped to the user and/or may notify a third party that the individual is interested in the product(s). For example, either user computing device 111c1 and/or distribution server(s) 102 may initiate the manufactured product 222r (e.g., absorbent article size 2) for shipment to the user. In such aspects, the product may be packaged and shipped to the user.

FIG. 3 illustrates an example one-to-one digital media modeling method 300 for optimizing digital media reach within digital networks, in accordance with various aspects disclosed herein. In various aspects, method 300 may be implemented, for example, by one or more processor(s) (e.g., processor 104) of one or more server(s) (e.g., distribution server 102).

As shown for FIG. 3, a first stage 302 of method 300 comprises defining a data seed and holdout seed for a given market segment 304. Market segment 304 may comprise an initial set of users, as identified or defined by user IDs (e.g., MAIDs, hashed users IDs, or other user information that identifies a user). Such users may have interest in a given product, e.g., as defined by demographics such as age, sex, or the like. For example, the product may comprise a diaper or other child product.

At section 304s as shown for FIG. 3, method 300 comprises generating, by one or more processors (e.g., processor 104 of server(s) 102), a data seed 304s defining a seed audience (e.g., seed audience 170) of users defined by targeting criteria for a digital media asset. The seed audience may comprise a representative or test audience for testing the digital media asset. In some aspects, the data seed may be an input file or otherwise a data structure that comprises a seed audience (e.g., fathers of children 7-36 months old). Such data may be sourced, at least in part, from database data and/or data obtained via a networked source (e.g., from database 105 and/or open web channel 130) and may comprise at least one of: one or more consumer demographic attributes, one or more consumer behavioral attributes, or one or more consumer consumption pattern attributes. By way of non-limiting example, this group of users may comprise mothers expecting to be mothers within nine months; mothers of children under three years of age, fathers of children who are toddlers (e.g., between ages 1-3), or the like.

In various aspects, creation of the data seed comprises generating the data seed with first party data sourced from a proprietary dataset defining direct interactions with the seed audience of users. For example, creation of the data seed with first party data may comprise collection consumer identifiers (e.g., email address or Mobile Advertising IDs (MAIDs)) and DOBs of their babies, in full compliance with local regulation, in order to enable targeting of users of a specific product category (e.g., for diapers or childcare products) at scale. The first party data may be part of a proprietary database (e.g., database 105) of user information. For example, the data may comprise first party data defining activities that users engage in themselves (e.g., registration, user traits, user actions). Such first party data may be collected or tracked by app 108 and/or open web channel 130 and aggregated in data sources database 105. This first party data may be sent via batch file uploads and API calls into a CDP (customer data platform) hosted on a cloud platform (e.g., server(s) 102) where the data is merged, harmonized, and/or and stored. The cloud platform (e.g., severs 102) may also be leveraged for analytical purposes to perform measurement, reporting, as well as predictive modeling. By leveraging such data, seed audiences (e.g., seed audience 180) may be created within a cloud or CDP ecosystem, and syndicated to destinations (activation platforms) via native API integrations. Additionally, or alternatively, seed data or otherwise first part data or proprietary data may be used to create the seed audience and perform lookalike expansion as described herein.

In various aspects, the proprietary dataset is used to generate a data seed (e.g., data seed 304s). Proprietary datasets can include data enrichment comprising direct interactions between users, brand, and products. For example, in various aspects, the proprietary dataset defines direct interactions that comprises one or more of: a type of product purchased by a user, a number of products purchased by the user, and/or a frequency of the product as purchased by the user. As an example, purchase data identified via app usage (e.g., app 108) can be used to define which user(s) are buying which product(s), and with what frequency. This information allows further personalization, targeting, and therefore reduced network transmission waste for marketing campaigns.

In various aspects, the data seed can be automatically generated upon or after receiving the data defining the audience of users interacting with the app. For example, in some aspects, automatic generation of a data seed comprises data flow automation in real-time or near-real-time (e.g., every minute, every 30 minutes, or every hour). In such aspects, data collected or aggregated into database 105 and/or open web channel 130 is used to automatically generate the data seed in real-time or near-real-time, where the data seed can be used as input into method 300, or as otherwise described herein, as part of a data flow automation implementation. Such automated updates contribute to improving targeting accuracy because the data used is highly relevant and with respect to recent user activity. The data flow automation of the present invention is superior to prior art methodologies that rely on manual data extraction (e.g., from customer relationship management (CRM) databases) and manual upload for media creation and output, which could take up to several days depending on human capital available. Further, such prior art processes are subject to user error, which the data flow automation of the present invention eliminates.

In various aspects, the digital media asset may comprise a digital media advertisement (e.g., digital media asset 204) configured for display on the user devices of targeted users (e.g., one or more of computing devices 111c1-111c3). Still further, in various aspects, a digital media asset can be transferred to an app (e.g., app 108) executing on a user device (e.g., computing device 111c1). Proprietary data, such as user interactions, can be captured via the app 108, and, in turn used with further one-to-one modeling to generate increased accuracy and reduce network traffic further. In particular, users interacting with the app can generate first party data that comprises data defining an audience of users interacting with the app. For example, proprietary data (e.g., first user data) may consist of data inputs (e.g., data about individual consumers and/or their activity), media inputs (e.g., digital media assets or other communications with consumers that may include a personalized message based on that data), and/or data architecture (e.g., data that facilitates data flow between data inputs and outputs as received to and from consumers, respectively). The data architecture may comprise different tools allowing collection, storage, and leverage of consumer data for targeting via media platforms and automatically updating data seeds (e.g., data seed 304s) in real-time or near real-time. Data inputs can include, for example, user activity via a website and/or mobile app (e.g., app 108). User interaction and activity with the website and/or mobile app is used to generate data (e.g., big data) that may be stored on a database (e.g., database 105). Such data may comprise emails, MAIDs, or other information as described herein that that can be used for targeting specific users. Still further, media outputs (e.g., digital media assets) may be split into paid media distribution (e.g. programmatic DSP, FACEBOOK media, and YOUTUBE media) and owned or operated media (e.g. CRM emails, in-app communication, or the like).

Still further, at first stage 302 of method 300 may comprise generating a holdout dataset 304h comprising a holdout audience of users (e.g., holdout audience 180) defined by the targeting criteria for the digital media asset. The holdout audience of users is different from the seed audience of users of the data seed. In various aspects, the holdout dataset may comprise a control or representative dataset for that does not receive the digital media asset.

More generally, data for data seed 304s and holdout dataset 304h may be loaded from a database and/or third party data source (e.g., database 105 and/or open web channel 130). The data may comprise user demographic data, user interaction data, and/or user behavioral data (e.g., purchase data) comprising interaction with an app (e.g., app 108). In the example of FIG. 3, data seed 304s and holdout dataset 304h is split into test (93.75%) and control (6.25%) data groups, respectively. The data seed (e.g., test group data) can be used in two general ways. First, via direct targeting through media campaigns. Second, such data may also be used as a seed for lookalike audience building using media platform DMPs (Data Management Platforms), which consist of large numbers of consumer cookies or Mobile IDs). This is described herein, for example, for FIG. 3 at sections 312, 322, and 332. Data seed 304s can be optimized by using highly predictive recency signals, for example the past three months of purchasing activity of a specific product (e.g., diapers pants size large).

$$On Target Reach = \frac{Exposed Consumers ∩ Consumers in Holdout Dataset}{Consumers in Holdout Dataset}$$

Holdout dataset 304h is held back and the users of such dataset are not directly targeted. However, a portion of these users can be exposed, as the lookalike algorithms can find these same consumers in the destination media platforms, such as THETRADEDESK (TTD) or FACEBOOK. A digital media asset for a given product can be created and provided to the users associated with the data seed 304s (and not the holdout dataset 304h). Reaction or impression data can be collected as users interact with the digital media asset. For example, a list of user IDs that have been exposed to the digital media asset may be collected and matched against the data seed 304s and/or holdout dataset 304h. For example, a high match rate with the holdout dataset 304h signifies high on-target reach, as the media platform, in such circumstances, would have reached many of the consumers intended. This can be referred to as on-target reach, which can be defined by the following On Target Reach formula:

The On Target Reach formula provides a percentage value defining the relevance and completeness of user IDs in the media DMP used for reaching consumers—if a media platform has a very low on-target reach, it suggests that the media platform is not useful because even improving accuracy will not allow enough targeted reach of intended consumers. An example is a DMP with majority of consumers too young or too old to have small children.

As shown for FIG. 3, a second stage 312 of method 300 comprises ID graph expansion. In the second stage 312, the data seed 304s is provided, e.g., via processor 104 of server(s) 102, to a userbase (e.g., database 105 and/or data of open web channel 130). The userbase may store unique user information. The userbase may comprise identity graph (ID graph) 314s which is software for a database, or is a database itself, that stores identifiers that correlate with individual customers or otherwise users. Such identifiers could be, by way of non-limiting example, usernames, emails, phone numbers, cookies, and/or offline identifiers such as loyalty card numbers. In the example of FIG. 3, identity graph 314s is represented by TAPAD ID graph, which is a commercial ID graph implementation.

With reference to FIG. 3, in various aspects, at least a portion 304p of the data seed 304s is expanded by merging the user data of the seed audience of users (e.g., seed audience 170 as identified within data seed 304s) with the user data of the additional users identifiable by the ID graph or otherwise within the userbase. For example, expansion may comprise using identity graph 314s to expand potential targeted users (e.g., by using 1 ID per user, e.g., a parent for a childcare product) to an expanded set of IDs owned or controlled by a given user. For example, every computing device or software thereof (e.g., computing device 111c1 and/or browser) of a given user would have its own ID (e.g., cookies, MAIDs, etc.). Such IDs can have a limited lifespan and thus change frequently. The ID graph 314s can manage and/or correlate the IDs or otherwise connections to users in real-time and/or near real-time. In one example, ID graph 314s can be implemented or used to match user (based on their IDs) with their respective IDs in the userbase (e.g., database 105) and merge user data with the additional data points for the respective users based on their identifiers. These data points can vary from sociographic and demographic (e.g., age, gender, income, or the like) to online behaviors such as used device, impression data, a website that a user has been served an impression on, affinities based on the content of the website they have been served, or the like.

Because data seed 304s or portion 304p thereof comprises user identifiers (e.g., mobile IDs or cookie values, etc.) for each user of the seed audience of users (e.g., seed audience 170), a merged dataset 316 can be created by matching or expanding the user identifiers to corresponding user identifiers of the user data of the userbase. The merged dataset 316 can then be provided to a lookalike algorithm, e.g., look alike algorithm 322a.

With reference to FIG. 3, a holdout dataset (e.g., holdout dataset 304h) may be provided, e.g., via processor 104 of server(s) 102, to the userbase (e.g., database 105). Holdout dataset 304 may comprise a control dataset when compared to the data of data seed 304s. The userbase (e.g., database 105) may comprises user data of the holdout audience of users (e.g., holdout audience 180). In various aspects, at least a portion 304hp of the holdout dataset 304h is expanded to create a merged holdout dataset 316h by merging the user data of the holdout audience of users with the user data of the additional users. Such merging is executed or implemented the same or similar as described herein for merged dataset 316.

As shown for FIG. 3, a third stage 322 of method 300 comprises lookalike (LAL) audience creation. At section 322, method 300 comprises providing, by the one or more processors (e.g., processor 104 of server(s) 102), the data seed to lookalike algorithm 322a to generate a lookalike media model 324. Lookalike algorithm 322a may comprise software for merging and matching user IDs. In some examples, lookalike algorithm 322a be implemented by THETRADEDESK platform, although other platforms and/or software may be used, e.g., software executing on server(s) 102. Lookalike algorithm 322a is implemented or executed by applying the data seed 304s, portion 304p, and/or merged dataset 316 to a userbase comprising user data of additional users to generate the lookalike media model 324. The additional users may be those in userbase (e.g., database 105 or as sourced from open web channels 130). The lookalike media model comprises a campaign audience dataset 324 defining a plurality of audience datasets each having users selected from at least one of the seed audience (e.g., seed audience 170) or the additional users (e.g., users of database 105 and/or open web channels 130). Each of the plurality of audience datasets of the campaign audience dataset 324 has or defines a relevancy score.

In one example, lookalike algorithm 322a (e.g., as implemented by TTD) analyzes user data to identify patterns to create a lookalike media model 324 defining a profile for a given user group or segment (e.g., “fathers of toddlers”). The lookalike media model 324 may then be used to apply the given user group or segment applied the entire userbase, which may include different users and may comprise first party, second party, third party, or other party data. The output of the lookalike media model 324 may comprise one or more audience(s) (e.g., based on the first, second, third party data, etc.). Each audience is then assigned a probabilistic relevancy score, which is a percentage based score determined from the similarity of the users in a given audience versus the input seed audience. For example, one audience may be “fathers of toddlers” and may be part of a third party data group, and may have a 62% relevancy score.

As shown for FIG. 3, a fourth stage 332 of method 300 comprises digital media asset campaign creation or determination. In particular, at section 332, method 300 further comprises creating by the one or more processors (e.g., processor 104 of server(s) 102), an exposed lookalike audience dataset 334 by merging each of the plurality of audience datasets as determined with the lookalike media model 324. Each of the plurality of audience datasets used to create the lookalike audience dataset 334 have a relevancy score above a relevancy threshold value. (e.g., relevancy threshold value of 60% and where “fathers of toddlers” may be part of a third party data group having a 62% relevancy score above the relevancy threshold values). In this way, the exposed lookalike audience dataset 334 defines a subset of targeted users (e.g., those associated with or having a relevancy score above a threshold value). Said another way, a certain threshold value of relevancy score is selected or assigned, where all audiences that have a relevancy score above this threshold are merged to create a lookalike audience, e.g., lookalike audience dataset 334.

At section 334, method 300 further comprises transmitting, by the one or more processors (e.g., processor 104 of server(s) 102), the digital media asset (e.g., digital media asset 204) across a digital network 120 to a user device (e.g., computing device 111c1) of at least one user of the targeted users of the exposed lookalike audience (e.g., of lookalike audience dataset 334 and/or of seed audience 170). As described herein, the user device is configured to display (e.g., via app 108) the digital media asset (e.g., digital media asset 204) on a graphical user interface (GUI). After the digital media asset is transferred, then additional tracking or interaction with digital media asset can be recorded via app 108. For example, every device and browser (e.g., as implemented computing device 111c1) would have its own ID (e.g., cookies, MAIDs, etc.) and with a limited lifespan, where such information could be tracked via app 108.

In some aspects, prior to transmission over computer network 120 and/or after creation of lookalike audience dataset 334, the exposed lookalike audience dataset may be filtered to reduce the targeted users based on at least one of: one or more internet domains visited or one or more age demographics. For example, in such aspects, an additional targeting filter can be applied on the lookalike audience dataset 334 to filter out age and domains visited, with additional data insights determined by lookalike media model 324 or otherwise. For example, fathers of a certain age, in one example, would be filtered so as not receive digital media assets for an audience comprising fathers with toddlers.

As shown for FIG. 3, a fifth stage 350 of method 300 comprises digital media asset reach or accuracy measurement or determination. Fifth stage 350 comprises analyzing holdout dataset 304h, portion 304p thereof, and/or merged holdout dataset 316h comprising a holdout audience of users (e.g., holdout audience 180) defined by the targeting criteria for the digital media asset. The holdout audience of users is different from the seed audience of users of the data seed 304s.

A reach measurement value 356 can be determined for the digital media asset as transmitted based on the exposed lookalike audience dataset 334. For example, in some aspects, method 300 comprises determining reach measurement value 356 of the digital media asset (e.g., digital media asset 204). Reach measurement value 356 allows for objective measurement of, and determined reach for, digital media assets. This allows for determination of networked traffic of such digital media assets. By measuring and tracking user interaction, reach measurement value 356 which determines accuracy of the present cycle, and, as consequence, future cycles leading to the reduction of network traffic.

The reach measurement value may comprise an accuracy score 360. The accuracy score 360 measures the on-target accuracy, i.e., the percentage of consumers exposed that are in a target audience. In some aspects, accuracy score 360 can also be used as a measurement value of the digital media asset (e.g., digital media asset 204) itself, e.g., whether the ad was effective. The accuracy score 360 is based on an overlap 354 of the holdout audience of users (e.g., any one or more from dataset 304h, portion 304p thereof, and/or merged holdout dataset 316h) and the targeted users of the lookalike audience dataset 334 to exposure to the digital media asset (e.g., digital media asset 204). The holdout audience of users is not provided to the lookalike algorithm, and thus are holdouts for purposes of testing a control set of users. Further, the users measured for the accuracy score will be unique users 356 identified by reducing redundancies in the overlap 354 users, where redundancies may be created by a user having multiple IDs (e.g., cookies and IDs) across various devices, browsers, apps, or other software.

Accuracy score 360 improves digital asset transmission reduction by being implemented with an on-target reach value, e.g., optimizing for cost per on-target reach. For example, in one aspect, to scale digital asset transmission reduction, and to measure the accuracy score 360, two algorithm may be used (either alone or in combination). In a first algorithm, matching users based a third party purchase panel of users represents one matching algorithm. This third party panel must include many users (e.g., parents of young babies), but not exclusively, so it can be determined a percentage of consumers exposed but that do not have babies.

In a second algorithm, an on-target reach value may be multiplied by a maximum reachable user value and divided by total number of devices exposed. The users-in-universe implementation produces a value that is a maximum number of users potentially reachable in absolute terms. The formula used with the second algorithm is as follows:

$$On Target Accuracy = \frac{( On Target Reach \times Max . Reachable Users )}{Total Devices}$$

The maximum reachable users (in the above formula) may be determined by the following formula:

Max. Reachable Users=On Target Reach×Users in Universe total market (or specific market)

In some aspects, in the absence of third party data or a panel that includes sufficient and representative users (e.g., parents of babies and non-parents of babies), the second algorithm has proven sufficiently accurate to provide an absolute value of how accurate a campaign is and relatively, how to improve from campaign to campaign, e.g., cycles of transmissions of digital media assets, which can result in the reduction of digital transmissions in a computer network.

In various aspects, cost per on-target reach can be calculated to optimize the media platform mix for a given campaign objective and target audience:

$$Cost per On Target Reach = \frac{Campaign Cost}{Exposed Consumers ∩ Consumers in Control panel}$$

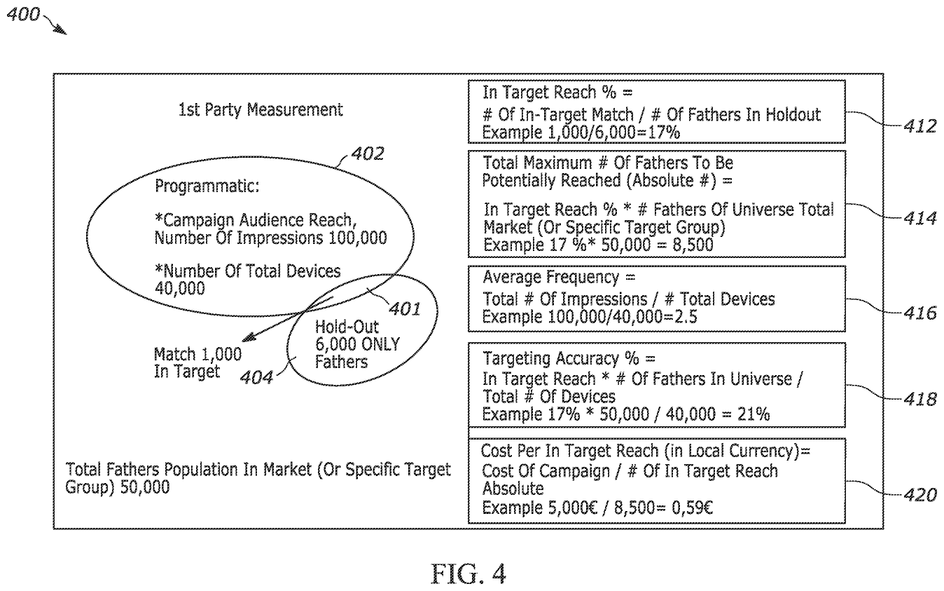

FIG. 4 illustrates example output of the one-to-one digital media modeling system and method as described herein for FIGS. 1 and 3, and in accordance with various aspects disclosed herein. For example, as shown for FIG. 4, overlap 401 (representative of overlap 354 of FIG. 3) is the holdout audience(s) of users 404 (e.g., representative of merged holdout dataset 316h of FIG. 3) and the targeted users of the lookalike audience dataset lookalike audience dataset 402 (e.g., representative of lookalike audience dataset 334 of FIG. 3) as exposed to the digital media asset (e.g., digital media asset 204). Values 412-420 represent values determinable for the overlap 401.

For example, overlap 401 identifies 1000 users (fathers) having been matched according to method 300 as described for FIG. 3, where the users comprised 100,000 impressions (e.g., interactions) of the users (e.g., 50,000 fathers) across 40,000 total devices (e.g., user computing devices 111c1-111c3 and 112c1-112c3). Using the algorithms and/or formulas as described herein (e.g., including for FIGS. 3 and 4) it can be determined that the in-target reach value was 17% (value 412), total maximum number of users to be potentially reached (absolute) is 8,5000 users (value 414), average frequency is 2.5 (value 416), targeting accuracy percentage is 21% (value 418), and cost per in target reach is 0.59 pounds in local currency (value 420). It is to be understood that algorithms and/or formulas and values of values 412-420 are examples and that other additional or different metrics may be determined with respect to comparing holdouts and lookalike audience datasets as described herein.

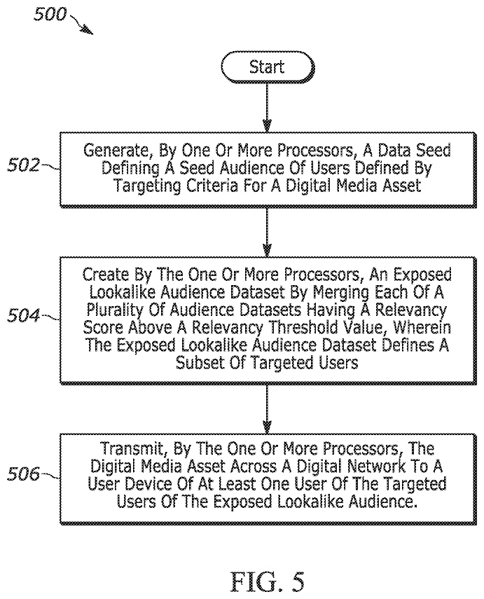

FIG. 5 illustrates a further example one-to-one digital media modeling method 500 for optimizing digital media reach within digital networks, in accordance with various aspects disclosed herein. One-to-one digital media modeling method 500 is similar to method 300 as described herein. Accordingly, the disclosure herein for method 300 applies in the same or similar manner for method 500.

At block 502, method 500 comprises generating, by one or more processors, a data seed defining a seed audience of users defined by targeting criteria for a digital media asset. In various aspects, the data seed may be generated from a plurality of different data sources having a plurality of different data formats, e.g., where the data is gathered or aggregated from various sources. The data or data seed may be generated to have a common format. Further, in some aspects, the digital media asset may comprise a user identifier of the user for tracking interaction with the digital media asset by the user. That is, the user identifier is added as a possible means of tracking or seeing activity digital media assets (e.g., digital ads) on the client side of a user device.

At block 504, method 500 comprises creating by the one or more processors, an exposed lookalike audience dataset by merging each of a plurality of audience datasets having a relevancy score above a relevancy threshold value, wherein the exposed lookalike audience dataset defines a subset of targeted users.

At block 506, method 500 comprises transmitting, by the one or more processors, the digital media asset across a digital network to a user device of at least one user of the targeted users of the exposed lookalike audience. In various aspects, the digital media asset may be configured for display on the user device (e.g., computing device 111c1). Still further, the digital media asset may be transmitted to a first user and a second user of the exposed lookalike audience such that the digital media asset is transmitted or pushed to the first user via a first channel (e.g., the FACEBOOK platform as represented by online platform(s) 140), and wherein the digital media asset is transmitted to the second user via a second channel (e.g., the GOOGLE platform as represented by online platform(s) 140).

### ASPECTS OF THE DISCLOSURE

The following aspects are provided as examples in accordance with the disclosure herein and are not intended to limit the scope of the disclosure.
1. A one-to-one digital media modeling method for optimizing digital media reach within digital networks, the one-to-one digital media modeling method comprising: generating, by one or more processors, a data seed defining a seed audience of users defined by targeting criteria for a digital media asset; providing, by the one or more processors, the data seed to a lookalike algorithm to generate a lookalike media model, wherein the lookalike algorithm applies the data seed to a userbase comprising user data of additional users, and wherein the lookalike media model comprises a campaign audience dataset defining a plurality of audience datasets each having users selected from at least one of the seed audience or the additional users, and each of the plurality of audience datasets having a relevancy score; creating by the one or more processors, an exposed lookalike audience dataset by merging each of the plurality of audience datasets having the relevancy score above a relevancy threshold value, wherein the exposed lookalike audience dataset defines a subset of targeted users; and transmitting, by the one or more processors, the digital media asset across a digital network to a user device of at least one user of the targeted users of the exposed lookalike audience, and wherein the user device is configured to display the digital media asset on a graphical user interface (GUI).
2. The one-to-one digital media modeling method of aspect 1 further comprising providing, by the one or more processors, the data seed to the userbase, wherein the userbase further comprises user data of the seed audience of users, wherein at least a portion of the data seed is expanded by merging the user data of the seed audience of users with the user data of the additional users.
3. The one-to-one digital media modeling method of any one of aspects 1-2, wherein the targeting criteria comprises at least one of: one or more consumer demographic attributes, one or more consumer behavioral attributes, or one or more consumer consumption pattern attributes.
4. The one-to-one digital media modeling method of any one of aspects 1-3, wherein the digital media asset comprises a digital media advertisement configured for display on the user devices of the targeted users.
5. The one-to-one digital media modeling method of any one of aspects 1-4, wherein the data seed comprises user identifiers for each user of the seed audience of users, and wherein a merged dataset is created by matching the user identifiers to corresponding user identifiers of the user data of the userbase, and wherein the merged dataset is provided to the lookalike algorithm.
6. The one-to-one digital media modeling method of any one of aspects 1-5, wherein creation of the data seed comprises generating the data seed with first party data sourced from a proprietary dataset defining direct interactions with the seed audience of users.
7. The one-to-one digital media modeling method of aspect 6, wherein the digital media asset is transferred to an application (app) executing on the user device, and wherein the first party data comprises data defining an audience of users interacting with the app.
8. The one-to-one digital media modeling method of aspect 6, wherein the proprietary dataset defining direct interactions comprises one or more of: a type of product purchased by a user, a number of products purchased by the user, or a frequency of the product as purchased by the user.
9. The one-to-one digital media modeling method of aspect 6, wherein the data seed is automatically generated upon or after receiving the data defining the audience of users interacting with the app.
10. The one-to-one digital media modeling method of any one of aspects 1-9 further comprising: generating a holdout dataset comprising a holdout audience of users defined by the targeting criteria for the digital media asset, and the holdout audience of users being different from the seed audience of users of the data seed; and determining a reach measurement value of the digital media asset, the reach measurement value comprising an accuracy score based an overlap of the holdout audience of users and the targeted users of the lookalike audience dataset to exposure to the digital media asset, wherein the holdout audience of users is not provided to the lookalike algorithm.
11. The one-to-one digital media modeling method of aspect 10, further comprising providing, by the one or more processors, the holdout dataset to the userbase, wherein the userbase further comprises user data of the holdout audience of users, wherein at least a portion of the holdout dataset is expanded by merging the user data of the holdout audience of users with the user data of the additional users.
12. The one-to-one digital media modeling method of any one of aspects 1-11 further comprising filtering the exposed lookalike audience dataset to reduce the targeted users based on at least one of: one or more internet domains visited or one or more age demographics.
13. A one-to-one digital media modeling system configured to optimize digital media reach within digital networks, the one-to-one digital media modeling system comprising: a server comprising one or more processors and one or more memories; and computing instructions stored on the one or more memories of the server, and when executed by the one or more processors, cause the one or more processors to: generate, by the one or more processors, a data seed defining a seed audience of users defined by targeting criteria for a digital media asset; provide, by the one or more processors, the data seed to a lookalike algorithm to generate a lookalike media model, wherein the lookalike algorithm applies the data seed to a userbase comprising user data of additional users, and wherein the lookalike media model comprises a campaign audience dataset defining a plurality of audience datasets each having users selected from at least one of the seed audience or the additional users, and each of the plurality of audience datasets having a relevancy score; create by the one or more processors, an exposed lookalike audience dataset by merging each of the plurality of audience datasets having the relevancy score above a relevancy threshold value, wherein the exposed lookalike audience dataset defines a subset of targeted users; and transmit, by the one or more processors, the digital media asset across a digital network to a user device of at least one user of the targeted users of the exposed lookalike audience.
14. A tangible, non-transitory computer-readable medium storing instructions for optimizing digital media reach within digital networks, that when executed by one or more processors cause the one or more processors to: generate, by one or more processors, a data seed defining a seed audience of users defined by targeting criteria for a digital media asset; provide, by the one or more processors, the data seed to a lookalike algorithm to generate a lookalike media model, wherein the lookalike algorithm applies the data seed to a userbase comprising user data of additional users, and wherein the lookalike media model comprises a campaign audience dataset defining a plurality of audience datasets each having users selected from at least one of the seed audience or the additional users, and each of the plurality of audience datasets having a relevancy score; create by the one or more processors, an exposed lookalike audience dataset by merging each of the plurality of audience datasets having the relevancy score above a relevancy threshold value, wherein the exposed lookalike audience dataset defines a subset of targeted users; and transmit, by the one or more processors, the digital media asset across a digital network to a user device of at least one user of the targeted users of the exposed lookalike audience.
15. A one-to-one digital media modeling method for optimizing digital media reach within digital networks, the one-to-one digital media modeling method comprising: generating, by one or more processors, a data seed defining a seed audience of users defined by targeting criteria for a digital media asset; creating by the one or more processors, an exposed lookalike audience dataset by merging each of a plurality of audience datasets having a relevancy score above a relevancy threshold value, wherein the exposed lookalike audience dataset defines a subset of targeted users; and transmitting, by the one or more processors, the digital media asset across a digital network to a user device of at least one user of the targeted users of the exposed lookalike audience.
16. The one-to-one digital media modeling method of aspect 15, wherein the data seed is generated from a plurality of different data sources having a plurality of different data formats, and wherein the data is generated to have a common format.
17. The one-to-one digital media modeling method of any one of aspects 15-16, wherein the digital media asset is transmitted to a first user and a second user of the exposed lookalike audience, and wherein the digital media asset is transmitted to the first user via a first channel, and wherein the digital media asset is transmitted to the second user via a second channel.
18. The one-to-one digital media modeling method any one of aspects 15-17, wherein the digital media asset is configured for display on the user device.
19. The one-to-one digital media modeling method of any one of aspects 15-18, wherein the digital media asset comprises a user identifier of the user for tracking interaction with the digital media asset by the user.
20. A one-to-one digital media modeling system configured to optimize digital media reach within digital networks, the one-to-one digital media modeling system comprising: a server comprising one or more processors and one or more memories; and computing instructions stored on the one or more memories of the server, and when executed by the one or more processors, cause the one or more processors to: generate, by one or more processors, a data seed defining a seed audience of users defined by targeting criteria for a digital media asset; create by the one or more processors, an exposed lookalike audience dataset by merging each of a plurality of audience datasets having a relevancy score above a relevancy threshold value, wherein the exposed lookalike audience dataset defines a subset of targeted users; and transmit, by the one or more processors, the digital media asset across a digital network to a user device of at least one user of the targeted users of the exposed lookalike audience.
21. A tangible, non-transitory computer-readable medium storing instructions for optimizing digital media reach within digital networks, that when executed by one or more processors cause the one or more processors to: generate, by one or more processors, a data seed defining a seed audience of users defined by targeting criteria for a digital media asset; create by the one or more processors, an exposed lookalike audience dataset by merging each of a plurality of audience datasets having a relevancy score above a relevancy threshold value, wherein the exposed lookalike audience dataset defines a subset of targeted users; and transmit, by the one or more processors, the digital media asset across a digital network to a user device of at least one user of the targeted users of the exposed lookalike audience.

### ADDITIONAL CONSIDERATIONS

Although the disclosure herein sets forth a detailed description of numerous different aspects, it should be understood that the legal scope of the description is defined by the words of the claims set forth at the end of this patent and equivalents. The detailed description is to be construed as exemplary only and does not describe every possible aspect since describing every possible aspect would be impractical. Numerous alternative aspects may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain aspects are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example aspects, the processor or processors may be located in a single location, while in other aspects the processors may be distributed across a number of locations.

The performance of certain of the operations may be distributed among the one or more processors, not only residing within a single machine, but deployed across a number of machines. In some example aspects, the one or more processors or processor-implemented modules may be located in a single geographic location (e.g., within a home environment, an office environment, or a server farm). In other aspects, the one or more processors or processor-implemented modules may be distributed across a number of geographic locations.

This detailed description is to be construed as exemplary only and does not describe every possible aspect, as describing every possible aspect would be impractical, if not impossible. A person of ordinary skill in the art may implement numerous alternate aspects, using either current technology or technology developed after the filing date of this application.

Those of ordinary skill in the art will recognize that a wide variety of modifications, alterations, and combinations can be made with respect to the above described aspects without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular aspects of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A one-to-one digital media modeling method for optimizing digital media reach within digital networks, the one-to-one digital media modeling method comprising:
generating, by one or more processors, a data seed defining a seed audience of users defined by targeting criteria for a digital media asset;
providing, by the one or more processors, the data seed to a lookalike algorithm to generate a lookalike media model, wherein the lookalike algorithm applies the data seed to a userbase comprising user data of additional users, and wherein the lookalike media model comprises a campaign audience dataset defining a plurality of audience datasets each having users selected from at least one of the seed audience or the additional users, and each of the plurality of audience datasets having a relevancy score;
creating by the one or more processors, an exposed lookalike audience dataset by merging each of the plurality of audience datasets having the relevancy score above a relevancy threshold value, wherein the exposed lookalike audience dataset defines a subset of targeted users; and
transmitting, by the one or more processors, the digital media asset across a digital network to a user device of at least one user of the targeted users of the exposed lookalike audience, and wherein the user device is configured to display the digital media asset on a graphical user interface (GUI).

2. The one-to-one digital media modeling method of claim 1 further comprising providing, by the one or more processors, the data seed to the userbase, wherein the userbase further comprises user data of the seed audience of users, wherein at least a portion of the data seed is expanded by merging the user data of the seed audience of users with the user data of the additional users.

3. The one-to-one digital media modeling method of claim 1, wherein the targeting criteria comprises at least one of: one or more consumer demographic attributes, one or more consumer behavioral attributes, or one or more consumer consumption pattern attributes.

4. The one-to-one digital media modeling method of claim 1, wherein the digital media asset comprises a digital media advertisement configured for display on the user devices of the targeted users.

5. The one-to-one digital media modeling method of claim 1,
wherein the data seed comprises user identifiers for each user of the seed audience of users, and
wherein a merged dataset is created by matching the user identifiers to corresponding user identifiers of the user data of the userbase, and
wherein the merged dataset is provided to the lookalike algorithm.

6. The one-to-one digital media modeling method of claim 1, wherein creation of the data seed comprises generating the data seed with first party data sourced from a proprietary dataset defining direct interactions with the seed audience of users.

7. The one-to-one digital media modeling method of claim 6,
wherein the digital media asset is transferred to an application (app) executing on the user device, and
wherein the first party data comprises data defining an audience of users interacting with the app.

8. The one-to-one digital media modeling method of claim 6, wherein the proprietary dataset defining direct interactions comprises one or more of: a type of product purchased by a user, a number of products purchased by the user, or a frequency of the product as purchased by the user.

9. The one-to-one digital media modeling method of claim 6, wherein the data seed is automatically generated upon or after receiving the data defining the audience of users interacting with the app.

10. The one-to-one digital media modeling method of claim 1 further comprising:
generating a holdout dataset comprising a holdout audience of users defined by the targeting criteria for the digital media asset, and the holdout audience of users being different from the seed audience of users of the data seed; and
determining a reach measurement value of the digital media asset, the reach measurement value comprising an accuracy score based an overlap of the holdout audience of users and the targeted users of the lookalike audience dataset to exposure to the digital media asset, wherein the holdout audience of users is not provided to the lookalike algorithm.

11. The one-to-one digital media modeling method of claim 10, further comprising providing, by the one or more processors, the holdout dataset to the userbase, wherein the userbase further comprises user data of the holdout audience of users, wherein at least a portion of the holdout dataset is expanded by merging the user data of the holdout audience of users with the user data of the additional users.

12. The one-to-one digital media modeling method of claim 1 further comprising filtering the exposed lookalike audience dataset to reduce the targeted users based on at least one of: one or more internet domains visited or one or more age demographics.

13. A one-to-one digital media modeling system configured to optimize digital media reach within digital networks, the one-to-one digital media modeling system comprising:
a server comprising one or more processors and one or more memories; and
computing instructions stored on the one or more memories of the server, and when executed by the one or more processors, cause the one or more processors to:
generate, by the one or more processors, a data seed defining a seed audience of users defined by targeting criteria for a digital media asset;
provide, by the one or more processors, the data seed to a lookalike algorithm to generate a lookalike media model, wherein the lookalike algorithm applies the data seed to a userbase comprising user data of additional users, and wherein the lookalike media model comprises a campaign audience dataset defining a plurality of audience datasets each having users selected from at least one of the seed audience or the additional users, and each of the plurality of audience datasets having a relevancy score;
create by the one or more processors, an exposed lookalike audience dataset by merging each of the plurality of audience datasets having the relevancy score above a relevancy threshold value, wherein the exposed lookalike audience dataset defines a subset of targeted users; and
transmit, by the one or more processors, the digital media asset across a digital network to a user device of at least one user of the targeted users of the exposed lookalike audience.

14. A tangible, non-transitory computer-readable medium storing instructions for optimizing digital media reach within digital networks, that when executed by one or more processors cause the one or more processors to:
generate, by one or more processors, a data seed defining a seed audience of users defined by targeting criteria for a digital media asset;
provide, by the one or more processors, the data seed to a lookalike algorithm to generate a lookalike media model, wherein the lookalike algorithm applies the data seed to a userbase comprising user data of additional users, and wherein the lookalike media model comprises a campaign audience dataset defining a plurality of audience datasets each having users selected from at least one of the seed audience or the additional users, and each of the plurality of audience datasets having a relevancy score;
create by the one or more processors, an exposed lookalike audience dataset by merging each of the plurality of audience datasets having the relevancy score above a relevancy threshold value, wherein the exposed lookalike audience dataset defines a subset of targeted users; and
transmit, by the one or more processors, the digital media asset across a digital network to a user device of at least one user of the targeted users of the exposed lookalike audience.

15. A one-to-one digital media modeling method for optimizing digital media reach within digital networks, the one-to-one digital media modeling method comprising:
generating, by one or more processors, a data seed defining a seed audience of users defined by targeting criteria for a digital media asset;
creating by the one or more processors, an exposed lookalike audience dataset by merging each of a plurality of audience datasets having a relevancy score above a relevancy threshold value, wherein the exposed lookalike audience dataset defines a subset of targeted users; and
transmitting, by the one or more processors, the digital media asset across a digital network to a user device of at least one user of the targeted users of the exposed lookalike audience.

16. The one-to-one digital media modeling method of claim 15, wherein the data seed is generated from a plurality of different data sources having a plurality of different data formats, and wherein the data is generated to have a common format.

17. The one-to-one digital media modeling method of claim 15, wherein the digital media asset is transmitted to a first user and a second user of the exposed lookalike audience, and wherein the digital media asset is transmitted to the first user via a first channel, and wherein the digital media asset is transmitted to the second user via a second channel.

18. The one-to-one digital media modeling method of claim 15, wherein the digital media asset is configured for display on the user device.

19. The one-to-one digital media modeling method of claim 15, wherein the digital media asset comprises a user identifier of the user for tracking interaction with the digital media asset by the user.

20. A one-to-one digital media modeling system configured to optimize digital media reach within digital networks, the one-to-one digital media modeling system comprising:
a server comprising one or more processors and one or more memories; and
computing instructions stored on the one or more memories of the server, and when executed by the one or more processors, cause the one or more processors to:
generate, by one or more processors, a data seed defining a seed audience of users defined by targeting criteria for a digital media asset;
create by the one or more processors, an exposed lookalike audience dataset by merging each of a plurality of audience datasets having a relevancy score above a relevancy threshold value, wherein the exposed lookalike audience dataset defines a subset of targeted users; and
transmit, by the one or more processors, the digital media asset across a digital network to a user device of at least one user of the targeted users of the exposed lookalike audience.
